(19) United States
(12) Patent Application Publication
(10) Pub. No.: US 2012/0011906 A1
(43) Pub. Date: Jan. 19, 2012

(54) AUGER CAM LOCK

(76) Inventors: John B. Wildauer, Cherry Hill, NJ (US); Michael James Daciw, Aston, PA (US); Charles A. Patterson, Durango, CO (US); Leslie Kirk Walters, Shelby Township, MI (US)

(21) Appl. No.: 12/837,965

(22) Filed: Jul. 16, 2010

(51) Int. Cl. E05B 65/00

(52) U.S. Cl. 70/182

(57) ABSTRACT

A lock for an augur through which a cable passes has a body having a bore passing therethrough and a lever. The lever has a lever body mounted for rotation in the bore, the lever body having a portion for engaging the cable, and an arm attaching to the lever body for rotating the body and the flat portion into and out of engagement with the cable. The lock also has a contact point disposed in the bore for cooperating with the lever portion to trap the cable therebetween, and a support for guiding the cable therethrough. The support has a portion extending into the bore of the body, the portion having a first slot therein, the lever extending into the slot to contact the cable.

### BACKGROUND OF THE INVENTION

This application relates to auger and more particularly for an auger including a cam lock.

Augers are used for plumbing drains and the like. The augur may have a drum for holding a coiled snake, which usually is a cable or a flat wire. The snake has a snare at its leading end to grab clogs in the drain so that the clogs may be pulled out of the drain when the snake is withdrawn therefrom.

In operation, the snake is pulled out of the drum and pushed into the drain typically through and around curved or angled corners (like a trap) of a pipe until it reaches a clog. Upon reaching the clog, the snake must be anchored so that rotation of the auger also rotates the snake. As the snake rotates, it burrows its snare into the clog to hold onto it. The snake is then unsecured from the auger and is loaded back into the drum thereby pulling the clog and the snake out of the drain. The clog is then removed from the snare.

Typically the snake is anchored for rotation by means of a thumb screw. Thumb screws may be difficult to tighten and may damage the snake.

### SUMMARY OF THE INVENTION

According to an embodiment, a lock for an augur through which a cable passes has a body having a bore passing therethrough and a lever. The lever has a lever body mounted for rotation in the bore, the lever body having a portion for engaging the cable, and an arm attaching to the lever body for rotating the body and the flat portion into and out of engagement with the cable. The lock also has a contact point disposed in the bore for cooperating with the lever portion to trap the cable therebetween, and a support for guiding the cable therethrough. The support has a portion extending into the bore of the body, the portion having a first slot therein, the lever extending through the slot to contact the cable.

According to a further embodiment, a lock for a drum augur through which a cable passes has a body having a bore passing therethrough, and a lever. The lever has a lever body mounted for rotation in the bore, the lever body having a flat portion for engaging the cable, and an arm attaching to the lever body for rotating the body and the flat portion thereof into and out of engagement with the cable. The lock also has a contact point disposed in the bore for cooperating with the lever flat portion to trap the cable therebetween, and a support for guiding the cable therethrough.

These and other features of the present invention can be best understood from the following specification and drawings, the following of which is a brief description.

### BRIEF DESCRIPTION OF THE DRAWINGS

FIG. 1 a perspective view of a drum auger;

FIG. 2 is a cutaway perspective view of proportion of the drum auger and a cam lock; and

FIG. 3 is a schematic view of the portion of the drum auger and the cam lock of FIG. 2.

### DETAILED DESCRIPTION OF THE PREFERRED EMBODIMENT

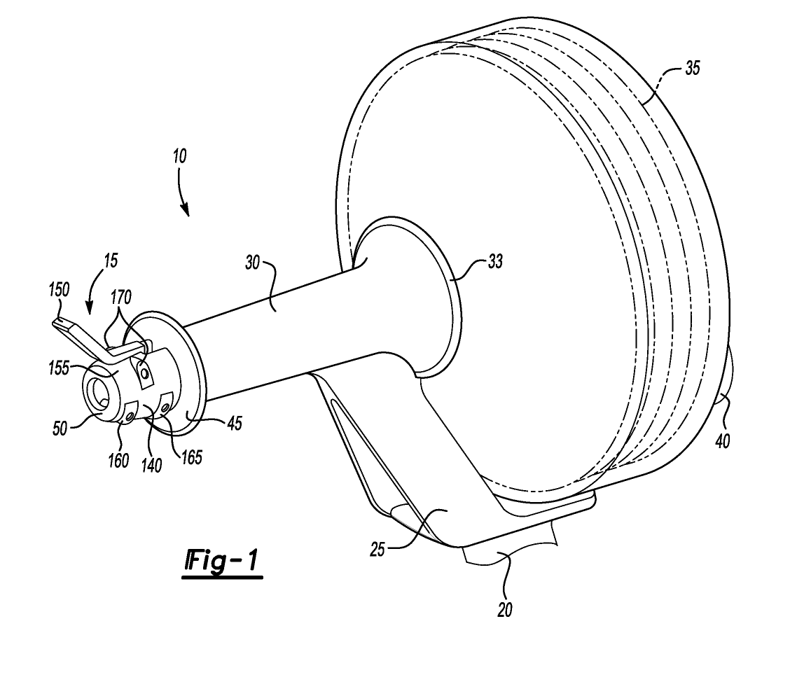

Referring to FIG. 1 a drum auger 10 that incorporates the cam lock 15 described herein is shown. The drum auger includes a handle 20, a bracket 25 attached to the handle 20, a support 30, a drum 35 rotatably attached to the support 30 as is known in the art (as by a bearing 33 or the like), a drum grip 40, a guard 45, and a nozzle 50.

Referring to FIGS. 1, 2 and 3, the support 30 has an exterior portion 55 attaching to the bracket 25 and an interior portion 60. The exterior portion 55 is cylindrical, though other shapes are contemplated herein, and has an interior shelf 65 at an outer end 70 thereof for holding the guard as will be discussed herein.

The interior portion 60 is shaped to closely fit (e.g., slightly less than interference fit so the parts may be assembled) within the exterior portion 55. The interior portion 60 has a circular body having a diameter D and a second interior portion 72 having a diameter D′ that is smaller than the diameter D. A curved transition section 75 joins the interior portion 60 and the second interior portion 72. A plurality of curved fingers 80, having spaces 85 therebetween, extends axially towards the drum 35 from the second interior portion 72. The curved fingers 80 create an opening 90 that is slightly larger than a diameter D″ of a cable 95. The interior portion 60 has two longitudinal grooves 100, 105 in the second interior portion 72 thereof for cooperating with the cam lock 15 as will be discussed herein. The curved fingers 80 cooperate with a retaining ring 82 that cannot fit through the fingers and is attached to the cable to retain the cable from being completely pulled out of the drum 35 and inadvertently be sent down the drain (not shown).

Referring to FIG. 3, the guard 45, which keeps a users hand on the exterior portion 55, has a disk-like body 110 having a left portion 115 that is flat, an outer rounded edge 120, a relatively flat right portion 125 extending at an angle relative to the left portion 115, and a contoured inner edge 130 that cooperates with the curved transition section 75 of the interior portion 60. A circular flange 135 extends axially towards the drum 35 from the right side of the body 125. The flange fits in the shelf 65 of the exterior portion 55.

Referring to FIGS. 1-3, the cam lock 15 has a body 140, which has a roughly cylindrical longitudinal bore 145 for receiving the second interior portion 72 therethrough, and a lever 150 for locking the cable 95 for rotation with the drum 35. An exterior surface 155 of the body 140 has a first pair of aligned bosses 160, a second pair of aligned bosses 165 and a third pair of aligned bosses 170 that extend into the bore 145. A first pin 175 and a second pin 180 extend through the first and second pair of bosses 160, 170 respectively. A third pin 185, which is held by the third pair of bosses 170, passes through lever 150 for rotation as will be discussed herein.

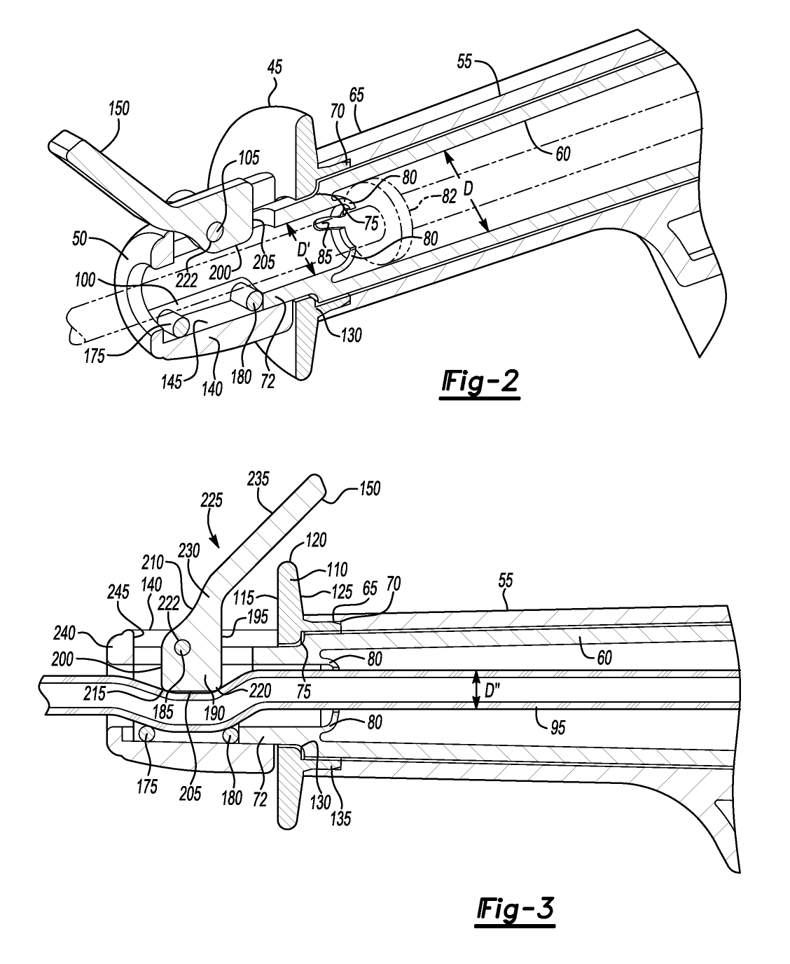

Referring to FIG. 3, the lever 150 has a roughly rectangular body 190 having a right side wall 195, a left side wall 200, a bottom wall 205 and a top portion 210. The left side wall 200 and the bottom wall 205 are joined by a first rounded portion 215 and the right side wall 195 and the bottom wall 205 are joined by a second rounded portion 220. The rectangular body 190 has an eccentrically placed hole 222 therein contiguous to the left side wall 200 and the top portion 210 within the rectangular body 19o. An arm 225 has a vertical portion 230 extending upwardly from the top portion 210 and an angular portion 235 extending from the vertical portion 230. In FIG. 2 the cam lock 15 is shown in an unlock portion with the left side wall 200 and the bottom wall 205 out of contact with the cable 95. In FIG. 3 the cam lock 15 is shown in a lock position wherein the right side wall 195, the first rounded portion 215, the second rounded portion 220 and the bottom wall 205 are in engagement with the cable 95.

The arm 225 and the pins 175, 180 are oriented to extend through the first and second bosses 160, 165 and fit within the longitudinal groove 100 in the interior portion 60 and the third pin 185 passes through eccentrically placed hole 222. The nozzle 50 is an annulus having a rounded outer surface 240 and a flat inner portion 245.

To construct the drum augur 10, the interior portion 60 is inserted into the exterior portion 55, the contoured inner edge 130 of the guard 45 cooperates with the curved transition section 75 of the interior portion 60 and circular flange 135 is received in the shelf 65 of the exterior portion 55. The parts may be glued together or sonically welded or the like. The body 140 is oriented on the interior portion 60 such that the pins 175, 180, 185 may be inserted through the bosses 160, 165. 180 to locate the pins 175, 180, 185 and the lever 150 in the longitudinal grooves of the interior portion 60 of the support. The flat inner portion 245 is attached to the body 140 to guide the cable 95 into and out of the support 30.

In operation, the cable 95 is fed through the support 30, the cam lock 15 and the nozzle 50. Once a snag (not shown) or a trap or a bend in the pipe (not shown) is reached, the arm 225 is rotated into the closed position (see FIG. 3) in which the left side wall 200 curved portion engages the cable 95 and drives it against the pin 180. As the lever continues to rotate, the bottom wall 205 drives the cable 95 downwardly and then the second rounded portion 220, between the right side wall 195 and the bottom wall 205 portion, drive the cable 95 against the pin 180, while the left rounded portion and the bottom wall 205 drive the cable against the pin 175 thereby locking the cable 95 against movement within the cam lock 15. The left side wall 200, the first rounded portion 215, the bottom wall 205 and the second rounded portion 220 drive the cable 95 against the pins (which act as contact points) 175, 180 at an angle that the cable 95 is not damaged but is securely locked for rotation with the drum 35. A user will appreciate that the angle may change for each cable 95 depending on cable dimensions, materials and other characteristics. A user can then rotate the cable 95 by means of the drum grip 40 on the drum 35 (see FIG. 1) to engage the snag (not shown) or navigate through the trap or bend (not shown). The guard 45 minimizes a chance that the arm 225 over-rotates. The eccentrically placed hole 222 of the rectangular body 190 allows the rectangular body to lock the cable in an over-center manner.

Once the snag is engaged, the arm is rotated in the counter clockwise direction to free the cable 95 (see the position of the lever in FIG. 2) for extraction from the drain (not shown) into the drum 35.

Because the cam lock 15 uses the principles of levers, the drum auger 10 or similar device, is relatively simple to use compared to a screw (not shown) and more particularly for those who have difficulty manipulating a screw or tightening a screw (not shown) in a significant manner. Because the first rounded portion 215 and the second rounded portion 220 of the rectangular body 190 are rounded, the probability that sharp edges, like the edges of a screw (not shown), would dig into and damage a cable 95 is minimized. The pins 175, 180 offer greater clamping force over a greater cable tolerance range over a cam lock that does not have this feature.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A lock for an augur through which a cable passes comprises:
a body having;
a bore passing therethrough,
a lever having;
a lever body mounted for rotation in said bore said lever body having a portion for engaging said cable, and
an arm attaching to said lever body for rotating said body and said portion thereof into and out of engagement with said cable, and
a contact point disposed in said bore for cooperating with said portion to trap said cable therebetween, and
a support for guiding said cable therethrough and having a portion extending into said bore of said body, said portion having a first slot therein, said lever extending through said first slot to contact said cable.

2. The lock of claim 1 further comprising a second slot in said support into which said contact point extends.

3. The lock of claim 2 wherein said contact point is a pin extending transversely through said bore.

4. The lock of claim 1 wherein said contact point is a pin extending transversely through said bore.

5. The lock of claim 1 wherein said lock further comprises a nozzle disposed on a front of the body.

6. The lock of claim 1 wherein said inner portion includes a guide extending axially within said inner portion.

7. The lock of claim 1 wherein said support has a second slot in which said contact points are disposed.

8. The lock of claim 1 wherein said support further comprises and inner portion and an outer portion, said outer portion.

9. The lock of claim 8 wherein said inner portion includes an extension that extends axially beyond said inner portion and includes said first slot therein.

10. The lock of claim 8 wherein said inner portion includes a second slot therein.

11. The lock of claim 10 wherein said contact point is disposed in said second slot.

12. The lock of claim 8 wherein said inner portion includes a guide extending axially within said inner portion.

13. The lock of claim 8 wherein a guard is trapped between said inner portion and said outer portion.

14. The lock of claim 8 wherein said lever body is mounted eccentrically in said body.

15. The lock of claim 1 wherein said lever body is mounted eccentrically in said body.

16. The lock of claim 1 wherein said portion has rounded edges.

17. The lock of claim 1 wherein said portion is flat.

18. A lock for a drum augur through which a cable passes comprises:
a body having;
a bore passing therethrough,
a lever having;
a lever body mounted for rotation in said bore said lever body having a portion for engaging said cable, and
an arm attaching to said lever body for rotating said body and said portion thereof into and out of engagement with said cable, and
a contact point disposed in said bore for cooperating with said lever portion to trap said cable therebetween, and
a support for guiding said cable therethrough.

19. The lock of claim 17 wherein said support further comprises and inner portion and an outer portion, said outer portion.

20. The lock of claim 18 wherein said inner portion includes an extension that extends axially beyond said inner portion and includes a first slot and a second slot therein.

21. The lock of claim 19 wherein said contact point is disposed in said second slot and said lever is disposed in said first slot.

22. The lock of claim 19 wherein a guard is trapped between said inner portion and said outer portion.

23. The lock of claim 17 wherein said lever body is mounted eccentrically in said body.

24. The lock of claim 17 wherein said portion has rounded edges.

25. The lock of claim 18 wherein said portion is flat.
